(19) United States
(12) Patent Application Publication
(10) Pub. No.: US 2018/0054721 A1
(43) Pub. Date: Feb. 22, 2018

(54) USING DEVICE LOCATION FOR EMERGENCY CALLS

(71) Applicant: Microsoft Technology Licensing, LLC, Redmond, WA (US)

(72) Inventors: Calvin Choe, Redmond, WA (US); Michael Kostersitz, Snohomish, WA (US); Shai Guday, Redmond, WA (US)

(21) Appl. No.: 15/243,883

(22) Filed: Aug. 22, 2016

(51) Int. Cl. H04W 4/22; H04L 29/06; H04M 3/51; H04W 4/02

(52) U.S. Cl. CPC H04W 4/22; H04L 65/1069; H04L 65/1016; H04W 4/02; H04L 65/1006; H04M 3/5116

(57) ABSTRACT

Embodiments relate to making IP-based (Internet Protocol based) emergency calls. A device is capable of making calls over the Internet to an IP Multimedia Subsystem (IMS) core to a Public-Safety Answering Point (PSAP). The device computes location information based on its actual or estimated physical location. The location information may be computed prior to making an emergency call, for instance by a location platform or service running on the computing device. When the device makes an emergency call, the device uses its location information to inform the emergency call. Specifically, a SIP message is formatted with the location information. The SIP message might be a SIP invitation formatted with a header indicating that an emergency call is being requested. The device might be capable of making only IP-based calls.

### BACKGROUND

Recently, cellular-capable end user (CCEU) devices and network/telephony infrastructure have evolved to allow CCEU devices to make cellular calls using either their cellular interfaces and protocols or using their data (non-cellular) interfaces and protocols, namely IP-based (Internet Protocol based) protocols. IP-based calling functionality in devices without a UICC/SIM (Universal Integrated Circuit Card/Subscriber Identity Module) card has been an afterthought and IP-based calling software has not been designed in ways that suit many IP-based calling scenarios. Rather, IP-based calling software has been designed under many of the assumptions that dictate how cellular or Voice over IP (VoIP) calling is handled. For example, when emergency calls are made, there is an assumption that the network infrastructure will identify the location of the calling device, route the call to the correct Public-Safety Answering Point (PSAP), notify the PSAP of the caller's location, etc.

Moreover, it has been assumed that when IP-based calls are made, they are done so by devices that are also cellular-capable (use a UICC/SIM Card) and are therefore registered with a Mobile Operator (MO), VoIP provider, or the like. Consequently, information about the caller's location, identity, etc., is assumed to be available through the MO or other downstream infrastructure. Although it has been recognized that IP-based emergency calls might be difficult to handle for downstream infrastructure, solutions have been limited. For example, some devices enable a user to manually input a static street address that is stored in a database for later use when the device originates an emergency call. An MO or other telephony entity handling an emergency call uses the calling device's identity to lookup the static manually pre-registered street location, which may or may not be accurate in the current situation.

In addition, although there are many well-known ways for end user devices to ascertain their current location, there has been an assumption that such location information is often unreliable or so slow to acquire that emergency calls are made without regard for a device's ability to determine its own location. Only the inventors have recognized that location-determining techniques have evolved to the point where data-only calling devices can be treated as reliable sources of calling locations when emergency calls are being made. The inventors alone have also recognized that certain techniques, discussed herein, can be used to avoid the problem of delaying initiation and setup of an emergency call while waiting for current location information to be acquired. Other techniques for incorporating a calling device's location into an IP-based call are described below.

### SUMMARY

The following summary is included only to introduce some concepts discussed in the Detailed Description below. This summary is not comprehensive and is not intended to delineate the scope of the claimed subject matter, which is set forth by the claims presented at the end.

Embodiments relate to making IP-based (Internet Protocol based) emergency calls. A device is capable of making calls over the Internet to an IP Multimedia Subsystem (IMS) core to a Public-Safety Answering Point (PSAP). The device computes location information based on its actual or estimated physical location. The location information may be computed and stored prior to making an emergency call, for instance by a location platform or service running on the computing device. When the device makes an emergency call, the device uses its location information to inform the emergency call. Specifically, a SIP message is formatted with the location information. The SIP message might be a SIP invitation formatted with a header indicating that an emergency call is being requested. The device might be capable of making only IP-based calls.

Many of the attendant features will be explained below with reference to the following detailed description considered in connection with the accompanying drawings.

### BRIEF DESCRIPTION OF THE DRAWINGS

The present description will be better understood from the following detailed description read in light of the accompanying drawings, wherein like reference numerals are used to designate like parts in the accompanying description.

FIG. 1 shows an end user device making an IP-based emergency call through an IP Multimedia System (IMS) core to a PSAP.

FIG. 2 shows details of cellular and IP-only calls.

FIG. 3 shows a sequence of an emergency call made by the device.

FIG. 4 shows details of a location platform.

FIG. 5 shows details of a SIP exchange.

FIG. 6 shows details of a computing device on which embodiments may be implemented.

### DETAILED DESCRIPTION

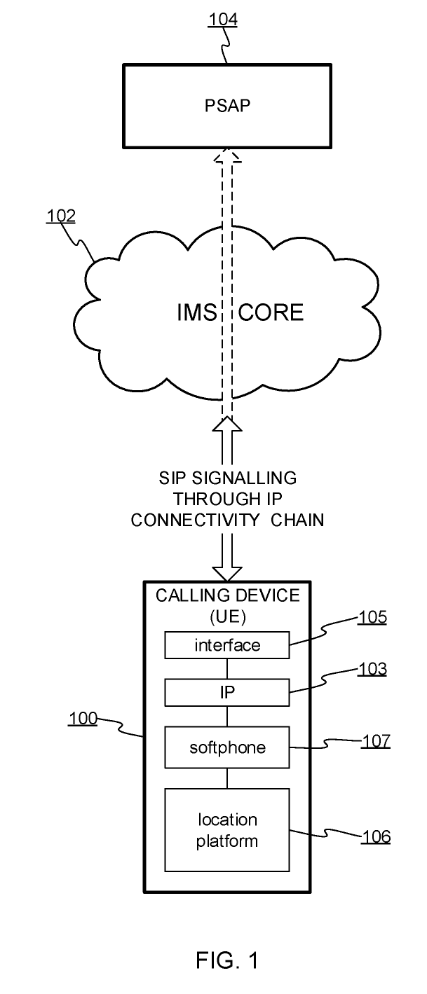

FIG. 1 shows an end user device (“device”) 100 making an IP-based emergency call through an IP Multimedia System (IMS) core 102 to a PSAP 104. The device 100 is configured with necessary components for IP communication, including an operating system with an IP protocol stack 103, a wired or wireless network interface card 105, application software for placing calls, e.g., a softphone 107, and other known components. In one embodiment, the device 100 is an IP-only device. As used herein, IP-only refers to devices that for various reasons lack the ability to communicate with and/or through cellular networks. For instance, an IP-only device might lack hardware needed for cellular communication, such as a Subscriber Identification Module (SIM), a cellular radio/interface, etc. An IP-only device might lack software for cellular communication. Generally, an IP-only device may be thought of as a device that is not designed for cellular communication but nonetheless is capable of IP-based communication.

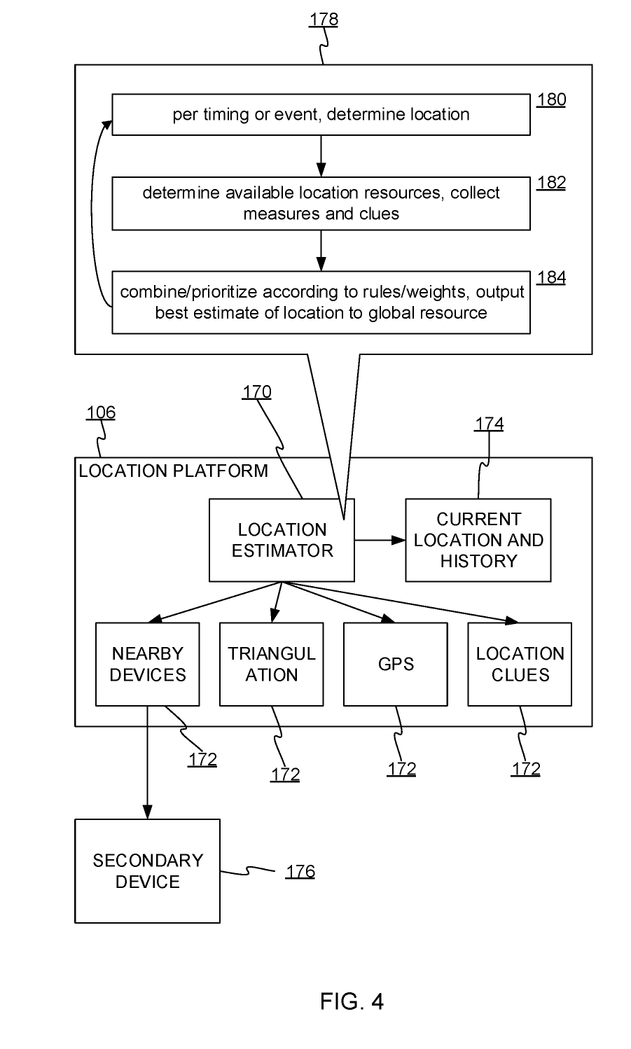

The device 100 includes a location platform 106, which provides location information for various SIP (Session Initiation Protocol) messages that might be sent by the device 100 when initiating or conducting a call. The location platform 106 is discussed later with reference to FIG. 4.

In addition to an IP protocol stack 103 and a network interface 105 for link-layer connections to networks, the device includes implementations of various protocols typically used for calls through IMS networks. For example, the device 100 may implement any/all of the Extensible Authentication Protocols (EAPs), the IP Security protocol (IPSec), SIP, the Real-time Transport Protocol (RTP), Transport Layer Security (TLS), and any other standard protocols used for voice or video IMS calls. The device 100 also includes application software for placing calls, for instance the softphone application 107, a contact manager, and the like. Application software for placing and managing calls may conform to the standard protocols noted above, with enhancements for incorporating location information into calls. In one embodiment, the softphone application 107 may implement calling protocols such as the Session Initiation Protocol (SIP).

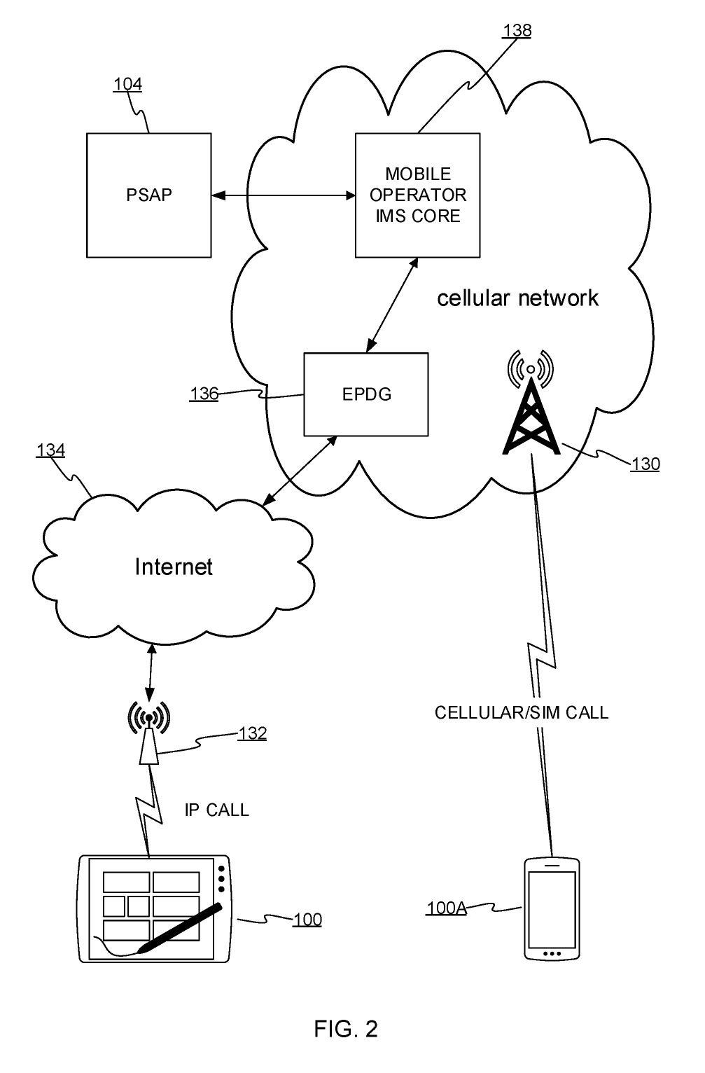

FIG. 2 shows details of cellular and IP-only calls. A cellular-capable device 100A forms a radio link to an antenna 130, establishes service using a SIM, and places calls in conformance with a cellular network protocol. In contrast, device 100, which may be an IP-only device, connects to a network access point 132 through wired or wireless media. In FIG. 2, the device 100 connects to the Internet 134 through a wireless access point. With IP connectivity established or available, the device 100 is able to make an IP-based emergency call.

Following is an example of how an IP-based emergency call can be made by the device 100. When a call has been initiated responsive to a user action or an automatic/heuristic determination that there is an emergency, IP connectivity is established if not already available. For example, the interface 105 may be a Wireless Fidelity (WiFi) interface and a WiFi connection may be established with the access point 132, which is connected to the Internet 134. With IP connectivity available, the device 100 may attempt to establish a connection with a gateway for linking Internet-based calls with the PSAP 104. Specifically, an IPSec tunnel is established with an Evolved Packet Data Gateway (EPDG) 136 or the like.

Authentication is established for a SIP session using an EAP authentication protocol such as the EAP-AKA (Authentication Key Agreement) or EAP-TLS protocol. The EPDG 136 then establishes (i) a SIP-TLS endpoint of a SIP session to the device 100 with a (ii) SIP-TLS endpoint of a SIP session that passes through an IMS core 138 to the PSAP 104. The IMS core 138 is typically provided by an MO. In sum, a SIP session is established between the PSAP 104 and the device 100. The RTP media stream is used to establish data exchange, through the EPDG 136, between the device 100 and the PSAP 104. Data exchange, for instance voice data, happens through the RTP as controlled by SIP signaling. Other mechanisms and IP-based protocols for accessing a PSAP through an Internet gateway may be used.

In embodiments where the device 100 is an IP-only device and lacks any cellular capacity or identity, SIP messages are used to provide the IMS core 138 and the PSAP 104 with information about the device 106 that it is making an emergency call.

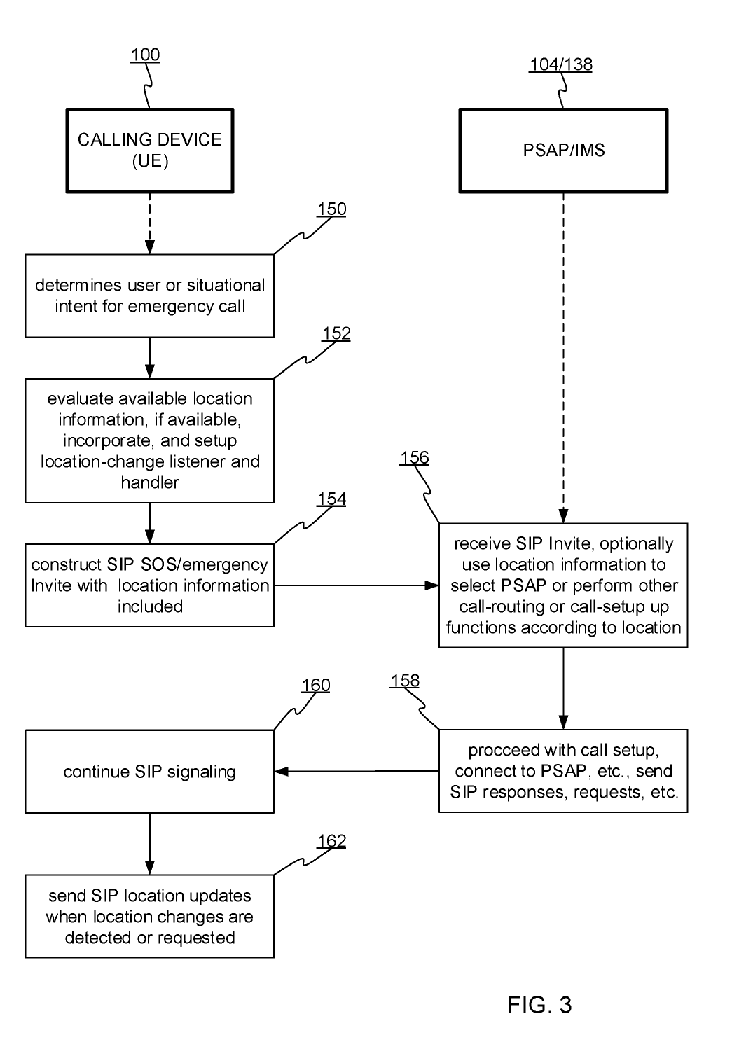

FIG. 3 shows a sequence of an emergency call made by the device 100. Initially, at step 150, application-layer software on the device determines that an emergency call is to be made. This origination of an emergency call can begin in a number of ways. For example, a user using softphone software dials an emergency phone number. Alternatively, a voice-recognition automated assistant is given a voice command such as “call the fire department”, which is recognized as a trigger to make an emergency call. In addition, an emergency call can be initiated automatically by a monitoring process that uses a heuristic to determine when an emergency call is needed. For example, the monitoring process might monitor a sensor signal such as air quality, temperature etc. Any known technique for identifying a potential emergency may be used.

After an emergency call has been triggered, a number of steps may be performed in parallel or in varying order. In one embodiment, at step 152 the calling device 152 checks for the availability of recent location information. A recency threshold may be checked to determine if the location information is sufficiently recent based on the application requirement, i.e., within the last hour, five minutes, etc. If location information is not available or if the location information is stale, a location is requested from the location platform106 through an application programming interface (API). The request may specify parameters suitable for an emergency call. For example, the request may specify a maximum amount of time for responding to the request, a preferred method or granularity of location measurement, etc. If a location is not available or cannot be acquired in sufficient time, the emergency call may proceed and location information may be conveyed through later SIP messages.

In addition to acquiring location information, the calling software may set up a hook to the location framework to receive updates corresponding to locational changes of the device 100. An event-driven model may be used where the location framework provides location update events either periodically or when the current location has changed by a threshold distance specified by the calling software. If the location is updated periodically to the calling software, the calling software may determine whether the location has changed enough to justify a new SIP message indicating a new location of the device making the emergency call.

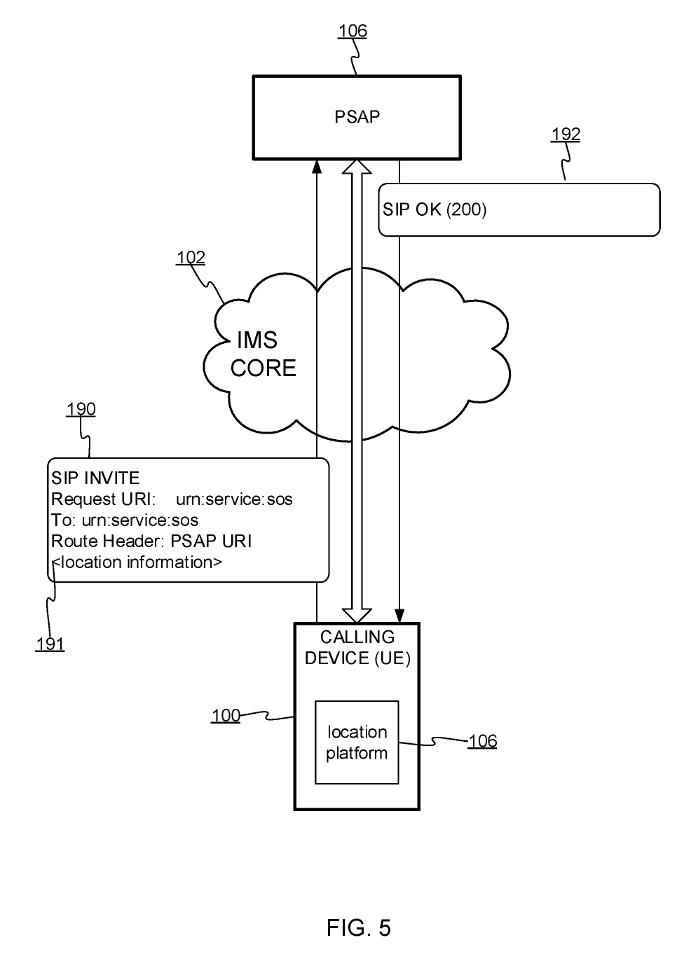

Although a stream of locations might be available and locations might be signaled to the PSAP (in SIP messages sent by the calling device) at various times time during the emergency call, in one embodiment, at step 154, location information is inserted into a SIP emergency invite message that is generated by the device and transmitted through the IP-based channel to the PSAP, as discussed later with reference to FIG. 5.

At step 156 the SIP emergency invite is received by the IMS core 138 and passed to the PSAP 104. Notably, because the calling device has included location information in the SIP invite message, the IMS core 138 and/or other telephony infrastructure can use the location in the location information to perform call-setup functions, call-routing, or select a PSAP assigned to the location in the location information. The location information may need to be transformed for SIP compliance depending on its purpose. At step 158 the IMS/PSAP proceeds with call setup, establishes a data stream for voice transmission (e.g., an RTP connection), and proceeds with known methods for implementing calls. At step 160, the device and the PSAP/IMS continue SIP signaling as needed. If, as discussed above, the calling application software determines that a location update is needed, for instance due to detection of a sufficient change in location or a transition to another emergency-handling district, the additional location updates may be issued via SIP update messages.

FIG. 4 shows details of the location platform 106. The location platform has a location estimator 170, various location measuring/reporting sources 172, and possibly a secondary device 176 to provide location information. The location estimator 170 implements a location-estimating algorithm 178. The location-estimating algorithm 178 repeatedly acquires raw location data from the measuring/reporting sources 172. At step 180, when a timer repeats, a location calculation iteration begins. At step 182 the measuring/reporting sources 172 are polled or queried, and at step 184 the available raw location information is used to compute a best-estimate for the current location of the device initiating the emergency call. Raw location data may be asynchronously pushed by or pulled from measuring/reporting sources 172.

Regarding step 182, any one or more measuring//reporting sources 172 may be used. For example, a triangulation module might triangulate cell tower signals to determine a geographic location, a Global Positioning Satellite receiver might provide coordinates, a set of location hints might be mapped to a geographic location, and so forth. For example, a device might have a history of being at different locations at different times/days and a location or location hint might be inferred accordingly. In one embodiment, the location estimator 170 combines the various sources in a weighted fashion, and/or prioritizes one source over the other, and so forth. The location estimator's logic can be guided by parameters passed in from the calling software, as discussed above. In other embodiments, complex multi-source location logic is not used and instead one or more sources are simply selected in a prioritized order or only one location resource is used.

As discussed above, to facilitate the quick issuance of an emergency SIP invite message, the location of the device may be computed prior to an emergency call being requested and the made available in a current-location file, history buffer, a configuration setting, etc. If a history of locations is used, the history can be used to determine whether the most recent location is reliable, even if stale. For example, if the history indicates that the device has been relatively stationary then a stale last-location can be used. In any case, the initial speedy use of a pre-computed last-location that might be old and incorrect can be followed by later SIP updates to correct or update the PSAP with the calling device's current location. In many cases, initial stale location information will suffice to allow downstream infrastructure to perform call setup/routing functions and select a PSAP, and later SIP location updates can inform the PSAP of the current and perhaps more-precise location of the device.

FIG. 5 shows details of a SIP exchange. As noted above, when the calling device initiates a call, the device generates an emergency SIP invite message 190. The SIP invite message 190 is formatted in conformance with the SIP protocol, which defines headers, flags, and other conventions for conveying location information in a variety of forms. Location information 191 is inserted into the SIP invite message 190. For example, the location information 191 can be in any of the forms defined in the 3GPP specification outlining SIP signaling for emergency calls. The SIP invite 190 is constructed with other known headers used for emergency SIP messages, such as a request URI (Universal Resource Identifier) indicating “SOS”, a route header, and so forth. In one embodiment, one or more headers other than location information may be based on the current/most-recent location obtained from the location platform. For instance, when an emergency call has been initiated without a user input for dialing, an emergency number can be looked up in a local number-location map according to the current/recent location and the found number can be included in the URN (Universal Resource Name). The same technique can be used even when an emergency number is included. If the dialed number is “911” (United States and Canada) but the current location indicates that the device is in Brazil, then the current location is used to lookup the emergency number for Brazil (“190”) and the correct emergency phone number for the current locale is incorporated into the SIM message's requested URN.

Once formulated, the SIP invite 190 is passed via the EPDG 136 or similar gateway, to the IMS core 102, which establishes the connection to the PSAP 106. In an embodiment where the device 100 is an IP-only device and lacks cellular communication hardware yet is capable of IP-based communication, the device is able to place an IP-only call (at least up to a gateway of an MO or IMS, if not further), and yet the calling device can inform that call with relatively current and possibly pre-computed location information. The physical location or locale of the device is determined by the device itself so that there is little chance that downstream infrastructure will be mistaken about the location of the emergency call, even when initially routing the emergency call. The physical location of the device can be determined by the device by direct measurement, by GPS triangulation, radio tower triangulation, etc. The physical location can also be approximated based on, or informed with, clues about the current operational or configuration state of the device. The current/recent location information that is computed by emergency calling device can also be used to configure non-location parameters of SIP messages (e.g., URNs), including within the initial SIP invite.

The initial SIP invite can also be formatted with different headers for different types of location information; one form of location information can be included for PSAP selection and another form of location information can be included for use by the PSAP. In situations where a device has only a brief window for communication, such as when a battery is nearly depleted, radio contact is about to be lost, or the device is about to be physically damaged, the ability to include device-determined location information can be invaluable; waiting for an initial SIP invite/reply handshake to complete before sending location information from an IP-only calling device can result in an inability to find the location of an emergency.

In another embodiment, when a calling device determines that an emergency exists and/or that an emergency call is being made, the device automatically sends an emergency message through other messaging systems. If the calling device has access to a list of contacts associated with the device or a user of the device, the contact list may be used to initiate another form of emergency communication. Messages may be sent to contacts in the contact list through channels such as email, instant messaging, social networks, etc.

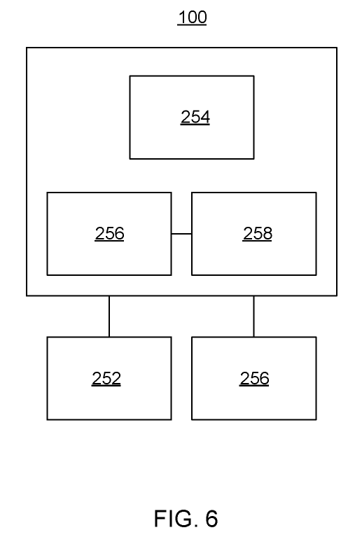

FIG. 6 shows details of the computing device 250 on which embodiments described above may be implemented. The host 100 shown in FIG. 1 is a type of computing device 250. The technical disclosures herein constitute sufficient information for programmers to write software, and/or configure reconfigurable processing hardware (e.g., field-programmable gate arrays), and/or design application-specific integrated circuits (application-specific integrated circuits), etc., to run on the computing device 250 to implement any of features or embodiments described herein.

The computing device 250 may have a display 252, a network interface 254 (or several), as well as storage hardware 256 and processing hardware 258, which may be a combination of any one or more: central processing units, graphics processing units, analog-to-digital converters, bus chips, FPGAs, ASICs, Application-specific Standard Products (ASSPs), or Complex Programmable Logic Devices (CPLDs), etc. The storage hardware 256 may be any combination of magnetic storage, static memory, volatile memory, non-volatile memory, optically or magnetically readable matter, etc. The meaning of the term “storage”, as used herein does not refer to signals or energy per se, but rather refers to physical apparatuses and states of matter. The hardware elements of the computing device 250 may cooperate in ways well understood in the art of computing. In addition, input devices may be integrated with or in communication with the computing device 250. The computing device 250 may have any form-factor or may be used in any type of encompassing device. The computing device 250 may be in the form of a handheld device such as a smartphone, a tablet computer, a gaming device, a server, a rack-mounted or backplaned computer-on-a-board, a system-on-a-chip, or others.

Embodiments and features discussed above can be realized in the form of information stored in volatile or non-volatile computer or device readable media. This is deemed to include at least media such as optical storage (e.g., compact-disk read-only memory (CD-ROM)), magnetic media, flash read-only memory (ROM), or any current or future means of storing digital information. The stored information can be in the form of machine executable instructions (e.g., compiled executable binary code), source code, bytecode, or any other information that can be used to enable or configure computing devices to perform the various embodiments discussed above. This is also deemed to include at least volatile memory such as random-access memory (RAM) and/or virtual memory storing information such as central processing unit (CPU) instructions during execution of a program carrying out an embodiment, as well as non-volatile media storing information that allows a program or executable to be loaded and executed. The embodiments and features can be performed on any type of computing device, including portable devices, workstations, servers, mobile wireless devices, and so on.

1. A method performed by a computing device comprised of a network interface, storage hardware, and processing hardware, the method comprising:
executing, by the processing hardware, an Internet Protocol (IP) stack to form IP-based connections over the network interface;
executing a network calling module configured to use a Session Initiation Protocol (SIP) to initiate IP calls through IP connections over the Internet;
responding to initiation of an IP call on the computing device by determining whether the IP call is an emergency call and by establishing an IP connection over the Internet between the computing device and an IP Multimedia Subsystem (IMS) core of a mobile operator (MO), wherein the IP call is an Internet call and is not placed over a cellular network;
in further response to the initiation of the IP call, establishing, over the IP connection, a SIP session between the device and the IMS core and exchanging SIP messages with the IMS core;
based on determining that the IP call is an emergency call, automatically:
inserting into one of the SIP messages an indication that the call is an emergency call;
obtaining location information automatically computed by a location service executing on the computing device, the location service computing the location information prior to initiation of the IP call according to a physical location of the computing device prior to initiation of the IP call;
inserting the location information into the one of the SIP messages; and
conducting the IP call between the computing device and a Public-Safety Answering Point (PSAP) via the Internet and the IMS core, wherein, in association with the call, the PSAP is automatically provided with the location information inserted into the one of the SIP messages or into another of the SIP messages, and wherein the IP call is not conducted over a cellular network.

2. A method according to claim 1, wherein the location information is computed by one or more signals that vary according to the physical location of the computing device.

3. A method according to claim 1, wherein the location information is inserted into a SIP invite message that is further comprised of a SIP header indicating that the SIP invite message is for an emergency call.

4. A method according to claim 1, wherein the location information is configured (i) to be used by infrastructure handling the emergency call to select the PSAP for the emergency call and/or (ii) to provide a location of the computing device to the PSAP.

5. A method according to claim 4, wherein the location information is inserted into the one or the other of the SIP messages in response to the computing device receiving a SIP message comprising a location request.

6. A method according to claim 1, wherein the location information is used to formulate a Uniform Resource Indicator (URI) that is inserted into the one or the other of the SIP messages by the computing device.

7. A method according to claim 1, wherein the computing device comprises an IP-only device.

8. A method according to claim 1, further comprising repeatedly automatically maintaining location data for the computing device to reflect the current physical location of the computing device, and wherein the location information inserted into the one or the other of the SIP messages is obtained from the automatically maintained location data of the computing device.

9. A computing device comprising:
processing hardware;
a network interface;
storage hardware storing (i) an operating system comprised of an IP protocol stack including an IP module including a transport module, and (ii) a soft phone comprising calling instructions configured to implement IP-based telephone calls through the IP protocol stack, the network interface, and the Internet, and not through any cellular network; and
the calling instructions configured to enable a user to input phone numbers and make calls to the phone numbers by initiating and conducting SIP sessions through the IP protocol stack, the calling instructions further configured to automatically determine when a call is an emergency call and to insert into a SIP invite message location information, the location information indicating a previous location of the computing device as determined by the computing device prior to initiation of the emergency call.

10. A computing device according to claim 9, wherein the location information is computed by a process that repeatedly re-computes the current location of the computing device.

11. A computing device according to claim 9, wherein the SIP invite message is configured with a header that indicates an emergency call.

12. A computing device according to claim 9, wherein the computing device is configured to authenticate the computing device with a gateway through the Internet, the gateway bridging an IMS core with a PSAP, wherein the IMS core and/or the gateway selects the PSAP for the call and intermediates data exchange between the computing device and the PSAP.

13. A computing device according to claim 12, wherein the SIP invite message is configured with the location information to enable the selection of the PSAP.

14. A computing device according to claim 9, wherein the computing device comprises an IP-only device capable of IP-only calling.

15. A method performed by a computing device, the method comprising:
determining that an IP-based emergency call is to be made by the computing device;
based on determining that an emergency call is to be made, the IP-based emergency call comprising a call that is conducted at least in part over the Internet and not over any cellular network, automatically obtaining location information computed by the computing device according to a physical location of the computing device, the location information computed prior to determining that the IP-based emergency call is to be made; and
forming a SIP session over the Internet, and not over any cellular network, to make the emergency call by including the location information in a SIP message sent by the computing device.

16. A method according to claim 15, wherein the location information is computed prior to the determining that an emergency call is to be made by a process executing on the computing device that repeatedly computes locations of the computing device independent of calls made by the computing device.

17. A method according to claim 15, further comprising inserting the location information into a SIP invite message sent by the computing device to initiate the emergency call.

18. A method according to claim 17, wherein the location information is configured to be used by an IMS core to select a PSAP and/or to be passed to a PSAP in association with the emergency call.

19. A method according to claim 18, wherein the location information comprises a calling locale used to select a PSAP and/or a physical location that is passed to the selected PSAP.

20. A method according to claim 15, wherein the computing device comprises a location framework that periodically updates a current location data stored by the computing device to reflect changing physical location of the computing device, and wherein the location information in the SIP message is obtained from contents of the current location data computed prior to determining that an emergency call is to be made.
